(19) United States
(12) Patent Application Publication
(10) Pub. No.: US 2017/0142295 A1
(43) Pub. Date: May 18, 2017

(54) DISPLAY DEVICE AND DISPLAY METHOD

(71) Applicant: NEC Display Solutions, Ltd., Tokyo (JP)

(72) Inventor: Kouichi OKADA, Tokyo (JP)

(21) Appl. No.: 15/321,133

(22) PCT Filed: Jun. 30, 2014
(86) PCT No.: PCT/JP2014/067354

§ 371 Date: Dec. 21, 2016

(51) Int. Cl. H04N 5/04; H04N 5/268

(52) U.S. Cl. CPC H04N 5/04; H04N 5/268

(57) ABSTRACT

A display device includes a signal detector configured to detect variations in a video input signal input thereto; a video delay measuring part configured to measure a video delay time concerning a video display operation based on the video input signal when the signal detector detects variations in the video input signal; a sound delay measuring part configured to measure a sound delay time concerning processing of a sound signal input thereto when the signal detector detects variations in the video input signal; and a sound delay processor configured to delay the sound signal based on the video delay and the sound delay time.

### TECHNICAL FIELD

The present invention relates to a display device, a display method, and a display program.

### BACKGROUND ART

Engineers have developed devices that measure luminance variations of test video data, which are changed from full black to full white on screen, with optical sensors, so as to detect delay times until images being displayed on screen, and thereby delay audio signals so as to establish synchronization between video and sound.

Additionally, engineers have developed devices that transmit video delay values and sound delay values to audio systems at the time of varying resolutions of videos being displayed, at the time of changing external inputs, at the time of changing video modes, and at the time of detecting connection with audio systems.

Furthermore, engineers have developed devices that detect luminance variations with photodiodes, which are positioned in proximity to video display faces, so as to measure time differences between video signals and audio signals.

For example, the above devices are disclosed in Patent Literatures 1 through 3.

### CITATION LIST

### Patent Literature

Patent Literature 1: Japanese Patent Application Publication No. 2010-183624

Patent Literature 2: Japanese Patent Application Publication No. 2010-273078

Patent Literature 3: Japanese Patent Application Publication No. H10-285483

### SUMMARY OF INVENTION

### Technical Problem

Due to variations of video input signals, however, the conventional devices are unable to predict delay times with respect to varied input signals and are thereby unable to set delay times.

The present invention aims to provide a display device, a display method, and a display program which are able to set delay times depending on varied input signals irrespective of any variations of input signals.

### Solution to Problem

A display device according to one embodiment of the present invention includes a signal detector configured to detect variations in a video input signal input thereto; a video delay measuring part configured to measure a delay time concerning a video display operation based on the video input signal when the signal detector detects variations in the video input signal; a sound delay measuring part configured to measure a delay time concerning processing of a sound signal input thereto when the signal detector detects variations in the video input signal; and a sound delay processor configured to delay the sound signal based on the delay time measured by the video delay measuring part and the delay time measured by the sound delay measuring part.

### Advantageous Effects of Invention

It is possible to provide a display device, a display method, and a display program which are able to set delay times depending on varied input signals irrespective of any variations of input signals.

### BRIEF DESCRIPTION OF DRAWINGS

FIG. 1 is a functional block diagram used to explain the configuration of a display device exemplified in the first embodiment.

FIG. 2 is a flowchart used to explain the operation of the display device exemplified in the first embodiment.

FIG. 3 is a flowchart used to explain the operation of the display device exemplified in the first embodiment.

FIG. 4A is a timing chart used to explain how to generate a mask pulse with respect to a video input signal serving as an analog signal used to generate a video detection signal.

FIG. 4B is a timing chart used to explain how to detect a data enable signal with respect to a video input signal serving as a digital signal used to generate a video detection signal.

FIG. 5 is a timing chart used to explain how to generate a video detection signal and a sound detection signal.

FIG. 6 is a timing chart used to explain how to measure a delay time.

FIG. 7 is a timing chart used to explain how to compensate for a delay time.

FIG. 8 is a functional block diagram used to explain the configuration of a display device exemplified in the second embodiment.

FIG. 9 is a functional block diagram used to explain the configuration of a display device exemplified in the third embodiment.

FIG. 10 is a side view of a display according to the third embodiment.

FIG. 11 is a functional block diagram showing the configuration of a display device exemplified in the fourth embodiment.

### DESCRIPTION OF EMBODIMENTS

Hereinafter, display devices according to the present embodiments will be described with reference to the drawings.

### First Embodiment

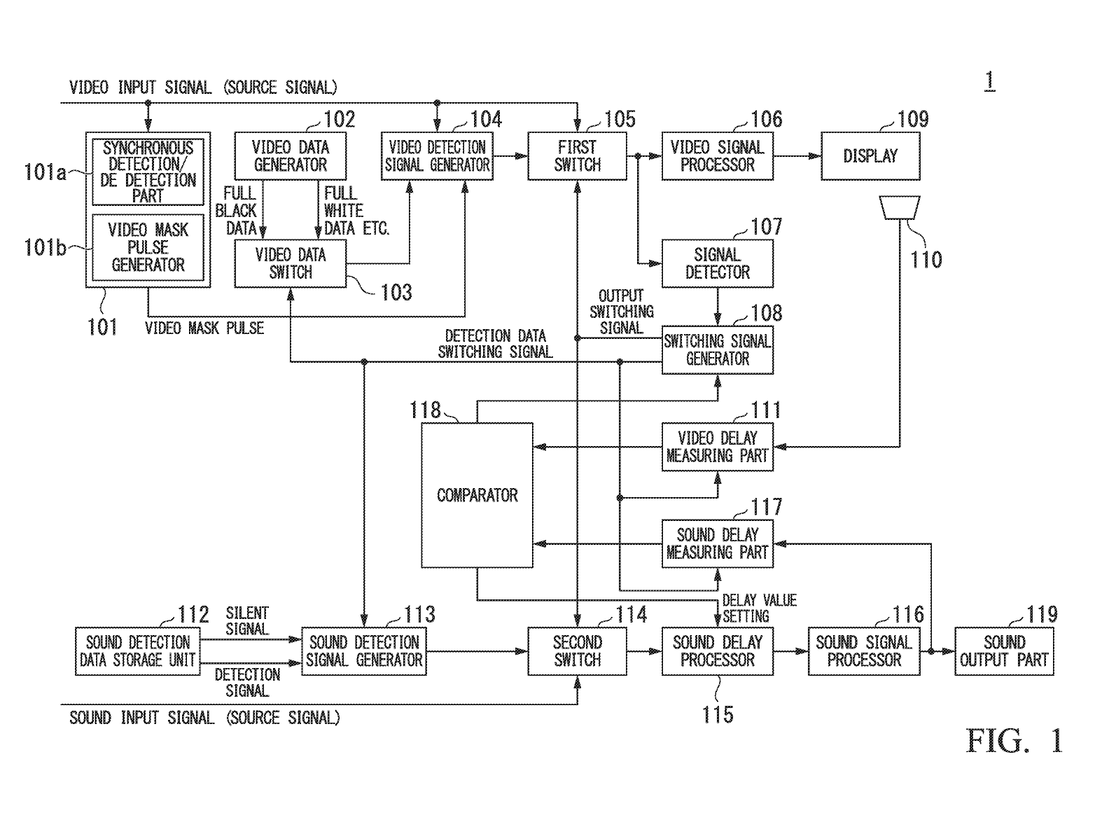

FIG. 1 is a functional block diagram used to explain the configuration of a display device exemplified in the first embodiment.

In FIG. 1, a display device 1 includes a video pulse generator 101, a video data generator 102, a video data switch 103, a video detection signal generator 104, a first switch 105, a video signal processor 106, a signal detector 107, a switching signal generator 108, a display 109, a video detector 110, a video delay measuring part 111, a sound detection data storage unit 112, a sound detection signal generator 113, a second switch 114, a sound delay processor 115, a sound signal processor 116, a sound delay measuring part 117, a comparator 118, and a sound output part 119.

The video pulse generator 101 includes a synchronous detection/DE detection part 101a and a video mask pulse generator 101b. A video input signal is input to the video pulse generator 101. Multiple types of video input signals are input to the video pulse generator 101. As types of video input signals according to classification using display methods, for example, it is possible to name an RGB signal, a component signal, a composite video signal, and the like. As types of video input signals according to classification using transmission methods, for example, it is possible to name an analog signal and a digital signal. According to classification using synchronization signals, it is possible to name separate sync, mix sync, sync on G (Green), and the like. It is possible to arbitrarily change the types of video input signals input to the video pulse generator 101. For example, when the display device 1 is connected with multiple types of unillustrated playback devices having different playback signals, video input signals will be changed upon switching of playback devices.

A video input signal at least includes a synchronization signal and a video source signal. A video input signal serving as a digital signal may further include a DE (Date Enable) signal. A video source signal includes a video component, corresponding to a video displayed on the display 109, within a video input signal.

The synchronous detection/DE detection part 101a of the video pulse generator 101 determines whether a video input signal being input thereto is an analog signal or a digital signal.

Upon detecting a video input signal serving as an analog signal, the synchronous detection/DE detection part 101a detects a synchronization signal included in a video input signal. When the synchronous detection/DE detection part 101a detects a video input signal serving as an analog signal, the video mask pulse generator 101b generates a video mask pulse based on the synchronization signal detected by the synchronous detection/DE detection part 101a. The video mask pulse carries out masking on a component of a video source signal corresponding to a video component.

Upon detecting a video input signal serving as a digital signal, the synchronous detection/DE detection part 101a detects a DE signal included in a video input signal. Subsequently, the video mask pulse generator 101b replicates the DE signal so as to reproduce the replicated DE signal as a video mask pulse.

The video data generator 102 generates specific video data. Specifically, it generates video data (or first video data) corresponding to a full black video (or a first video) and another video data (or second video data) corresponding to a full white video (or a second video). Herein, the full black video causes a video display area to be entirely displayed in black. The full white video causes a video display area to be entirely displayed in white. It is described later that the video detector 110 may detect a luminance difference between the first video and the second video. For this reason, it is possible to use the first video replacing the full black video with another video having a higher luminance than the full black video, while it is possible to use the second video replacing the full white video with another video having a lower luminance than the full white video.

The video data generator 102 generates and outputs the first video data or the second video data to the video data switch 103.

According to a detection data switching signal input by the switching signal generator 108, the video data switch 103 outputs either the first video data or the second video data to the video detection signal generator 104.

The video detection signal generator 104 generates a video detection signal based on the video mask pulse input by the video pulse generator 101 and the video data input by the video data switch 103.

Specifically, the video detection signal generator 104 generates a video detection signal under the following procedure. First, the video detection signal generator 104 replicates a video input signal being input thereto. As described above, a video input signal includes a video source signal (i.e. a first video source signal) and a synchronization signal (i.e. a first synchronization signal). Therefore, the replication of a video input signal includes the replication of a first video source signal and the replication of a first synchronization signal.

Next, the video detection signal generator 104 carries out masking by multiplying the first video source signal, included in the replication of a video input signal, by the video mask pulse. Additionally, the video detection signal generator 104 generates a second video source signal by replacing the masking part of the video source signal with the first video data or the second video data input by the video data switch 103. The video detection signal generator 104 generates the second video source signal while generating the video detection signal including a second synchronization signal identical to the replication of the first synchronization signal.

Herein, the first video detection signal replaces the video source signal with the first video data while the second video detection signal replaces the video source signal with the second video data. The video detection signal generator 104 generates the first video detection signal or the second video detection signal based on the first video data or the second video data input by the video data switch 103.

In the present embodiment, the video detection signal at least includes the second synchronization signal and the second video source signal; hence, the video detection signal further includes a DE signal with respect to the video input signal serving as a digital signal.

The present embodiment is designed to generate the second synchronization signal replicating the first synchronization signal so as to generate the same synchronization signal as the first synchronization signal; however, the second synchronization signal is not necessarily limited to the same synchronization signal as the first synchronization signal. For example, it is possible to detect the leading edge or the trailing edge with the first synchronization signal so as to generate the second synchronization signal based on the leading edge or the trailing edge.

The video detection signal generator 104 extracts a synchronization signal or a DE signal from a video input signal so as to output a video detection signal, synchronized with the video input signal, to the first switch 105.

The present embodiment is designed to maximize a luminance difference of a video displayed on the display 109 by use of a combination of first and second video detection signals such that the video detection signal generator 104 switches over and alternatively outputs the first video detection signal and the second video detection signal; however, the video detector 110 may use any combination providing a detectable luminance difference other than a combination of first and second video detection signals. For example, it is possible to use a combination of a video input signal and a first video detection signal or a combination of a video input signal and a second video detection signal.

In the present embodiment, the video detection signal generator 104 generates the second synchronization signal based on the first synchronization signal, generates the second video source signal based on the first video source signal, and thereby generates the video detection signal. However, it is possible to provide other modules for generating the second synchronization signal and for generating the second video source signal. That is, the display device 1 can be equipped with a synchronization signal generator configured to generate the second synchronization signal based on the first synchronization signal and a video signal generator configured to generate the second video source signal based on the first video source signal.

Upon receiving an input switching signal by the switching signal generator 108, the first switch 105 switches over a video input signal and a video detection signal input by the video detection signal generator 104 so as to send them to the video signal processor 106 and the signal detector 107.

The video signal processor 106 carries out video processing to convert an input video signal into a video signal displayable on the display 109. The video signal processor 106 carries out video processing aimed for an analog signal with respect to an input video signal serving as an analog signal. On the other hand, it carries out video processing aiming for a digital signal with respect to an input video signal serving as a digital signal. Therefore, the video signal processor 106 carries out different types of video processing depending on types of input video signals. For example, the video processing refers to color adjustment, picture quality adjustment, resolution adjustment, and the like. The video signal processor 106 outputs video signals subjected to video processing to the display 109.

The signal detector 107 detects variations of video input signals. For example, variations of video input signals refer to changes in types of video input signals. According to classification using display methods, as described above, video input signals can be classified into various types such as RGB signals, component signals, and composite signals. According to classification using transmission methods, video input signals can be classified into various types such as analog signals and digital signals. According to classification using synchronization signals, video input signals can be classified into various types such as separate sync, mix sync, and sync on G (Green). The signal detector 107 detects variations of video input signals as changes in types of video input signals.

The signal detector 107 may detect variations of video input signals as changes in frequencies of video input signals.

As delay times concerning display operations which will be described later, delay times occurring in the video signal processor 106 and the display 109 may differ depending on differences in types or frequencies of video input signals. Upon detecting variations of video input signals, the signal detector 107 outputs a detection flag, representing variations of video input signals being detected, to the switching signal generator 108.

The switching signal generator 108 generates control signals for switching over the functions of the video data switch 103, the sound detection signal generator 113, the first switch 105, and the second switch 114.

Upon receiving a detection flag from the signal detector 107 or upon receiving an explicit instruction given by a user operation, the switching signal generator 108 generates an output switching signal. For example, an explicit instruction given by a user operation is an instruction of executing compensation for delay times, which will be described later, by way of an operation of a user who operates an unillustrated push button or the like. In the present embodiment, the signal detector 107 automatically executes compensation for delay times upon detecting variations of video input signals; alternatively, it is possible to manually execute compensation for delay times by way of a user operation.

After sending an output switching signal, the switching signal generator 108 checks the predetermined setup time. After the predetermined setup time is elapsed, it sends an output switching signal to the first switch 105 and the second switch 114.

Upon receiving a processing-completion flag output from the comparator 118, the switching signal generator 108 stops sending an output switching signal. In this connection, the details concerning the operation of the comparator 118 and the processing-completion flag will be described later.

The display 109 displays a video based on a video signal given by the video signal processor 106. For example, the display 109 has any type of display device such as a cathode-ray tube, a liquid crystal display, a plasma display, an organic EL display.

The video detector 110 detects a video displayed on the display 109. For example, the video detector 110 is an optical sensor. The video detector 110 is able to measure the luminance of a video displayed on the display 109 by measuring the amount of light irradiated by the display 109 when displaying a video. For example, the luminance of a video displayed on the display 109 becomes low when a full black video is displayed on the display 109. On the other hand, the luminance of a video displayed on the display 109 becomes high when a full white video is displayed on the display 109. The video detector 110 detects variations of luminance of videos by measuring variations in the amount of incident light, thus detecting that a video displayed on the display 109 is changed from a full black video to a full white video. Upon detecting switching of videos, the video detector 110 sends a detection result to the video delay measuring part 111.

The video delay measuring part 111 measures a delay time concerning a video display operation. In the present embodiment, a delay time concerning a video display operation is a period of time counted from the timing at which the video delay measuring part 111 detects a detection data switching signal given by the switching signal generator 108 to the timing at which the video delay measuring part 111 receives a detection result of the video detector 110. The delay time depends on the times of processing video signals mainly in the video signal processor 106 and the display 109 (hereinafter, referred to as “the video signal processor 106 and its associated part”). The video delay measuring part 111 measures and sends the delay time to the comparator 118.

The sound detection data storage unit 112 stores sound signals so as to send them to the sound detection signal generator 113. In the present embodiment, the sound detection data storage unit 112 stores sound signals such as a silent signal and a detection signal (or a sound-emitting signal). Herein, a silent signal and a sound-emitting signal correspond to sound data having different volumes. The silence signal should differ from the detection signal by a certain volume difference which can be detected by the sound delay measuring part 117 which will be described later. Instead of storing a silence signal, the sound detection data storage unit 112 may send two sound-emitting signals having a predetermined volume difference to the sound detection signal generator 113.

The sound detection signal generator 113 generates two sound detection signals, i.e. a silence-type sound detection signal based on a silent signal given by the sound detection data storage unit 112 and a sound-emission-type sound detection signal based on a detection signal given by the sound detection data storage unit 112. Upon receiving a detection data switching signal output from the switching signal generator 108, the sound detection signal generator 113 switches its sound detection signal from a silence-type sound detection signal to a sound-emission-type sound detection signal, which is then sent to the second switch 114.

Upon receiving an output switching signal from the switching signal generator 108, the second switch 114 switches a sound input signal to a sound detection signal, given by the sound detection signal generator 113, thus sending the sound detection signal to the sound delay processor 115.

The sound delay processor 115 applies a predetermined delay time to the sound input signal or the sound detection signal input thereto. The sound delay processor 115 sets a delay correction value output from the comparator 118. The sound delay processor 115 temporarily stores a sound signal input thereto in an internal buffer. Subsequently, the sound delay processor 115 reads the sound signal, stored in the internal buffer, while delaying it depending on the delay correction value, thus sending it to the sound signal processor 116.

The sound signal processor 116 processes a sound signal given by the sound delay processor 115 so as to send it to the sound delay measuring part 117 and the sound output part 119.

The sound delay measuring part 117 measures a delay time concerning sound processing. In the present embodiment, the delay time concerning sound processing is a period of time counted from the timing at which the sound delay measuring part 117 receives a detection data switching signal output from the switching signal generator 108 to the timing at which the sound delay measuring part 117 receives a sound signal output from the sound signal processor 116. The delay time mainly depends on the time of processing sound signals in the sound signal processor 116. The sound delay measuring part 117 measures and sends the delay time to the comparator 118.

The comparator 118 compares the delay time measured by the video delay measuring part 111 and the delay time measured by the sound delay measuring part 117 so as to calculate a difference between delay times (or a differential time). The comparator 118 sends the differential time as a delay correction value to the sound delay processor 115. When the differential time falls within the predetermined range, the comparator 118 sends to the switching signal generator 108 a processing-completion flag indicating that the differential time falls within the predetermined range. The comparator 118 stores the range of differential times used to output a processing-completion flag. It is possible to store different ranges of differential times depending on types of video input signals. Alternatively, it is possible for a user to set the range of differential times in advance.

The sound output part 119 outputs sound based on sound signals input by the sound signal processor 116. For example, the sound output part 119 is a combination of an audio amplifier and a speaker.

The present embodiment is designed to directly supply sound signals, output from the sound signal processor 116, to the sound delay measuring part 117. However, it is possible to detect sound output from the sound output part 119 with a sound detection device such as a microphone, thus supplying a detection result to the sound delay measuring part 117.

By the way, delay times concerning video display operations may be varied depending on the contents of processing and the amounts of processing data in the video signal processor 106 and its associated part. As described above, the video signal processor 106 receives multiple types of video input signals. Therefore, the video signal processor 106 and its associated part undergo different delay times concerning video display operations depending on types of video input signals.

On the other hand, the sound signal processor 116 undergoes processing times in sound processing which may be hardly affected by types of video input signals. Additionally, processing times of sound signals bear lower processing loads compared to processing of video signals; hence, delay times due to processing of sound signals become smaller than delay times due to processing of video signals. Therefore, the timing of displaying videos on the display 109 may differ from the timing of outputting sound with the sound output part 119 based on types of video input signals.

Irrespective of different types of video input signals being input due to variations of input signals, the present embodiment is able to measure delay times depending on types of video input signals so as to set delay correction values to the sound delay processor 115 based on the measured delay times, thus synchronizing the timing of displaying videos on the display 109 with the timing of outputting sound with the sound output part 119 (or eliminating deviations or reducing deviations). It is unnecessary to predict and store a delay correction value for each type of video input signal in advance since the delay correction value is measured depending on variations of video input signals.

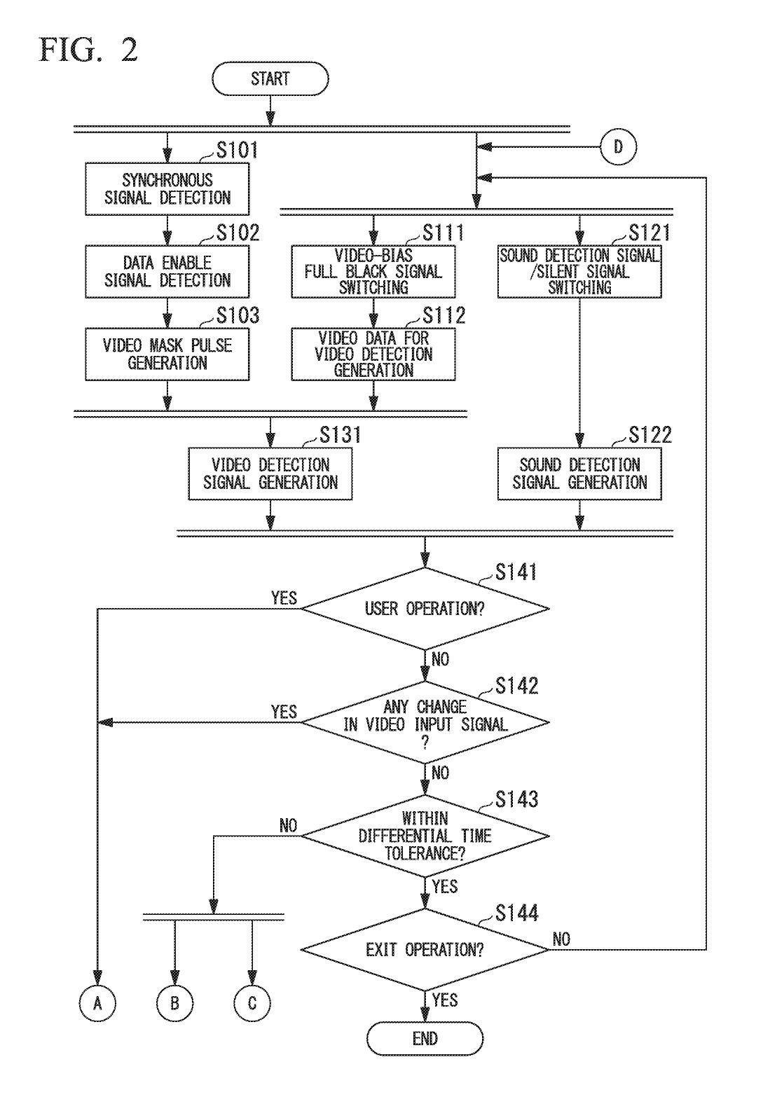

Next, the operation of the display device 1 according to the present embodiment will be described with reference to FIGS. 2 to 7. The following description will be made by appropriately referring to the configuration of the display device 1 described in FIG. 1.

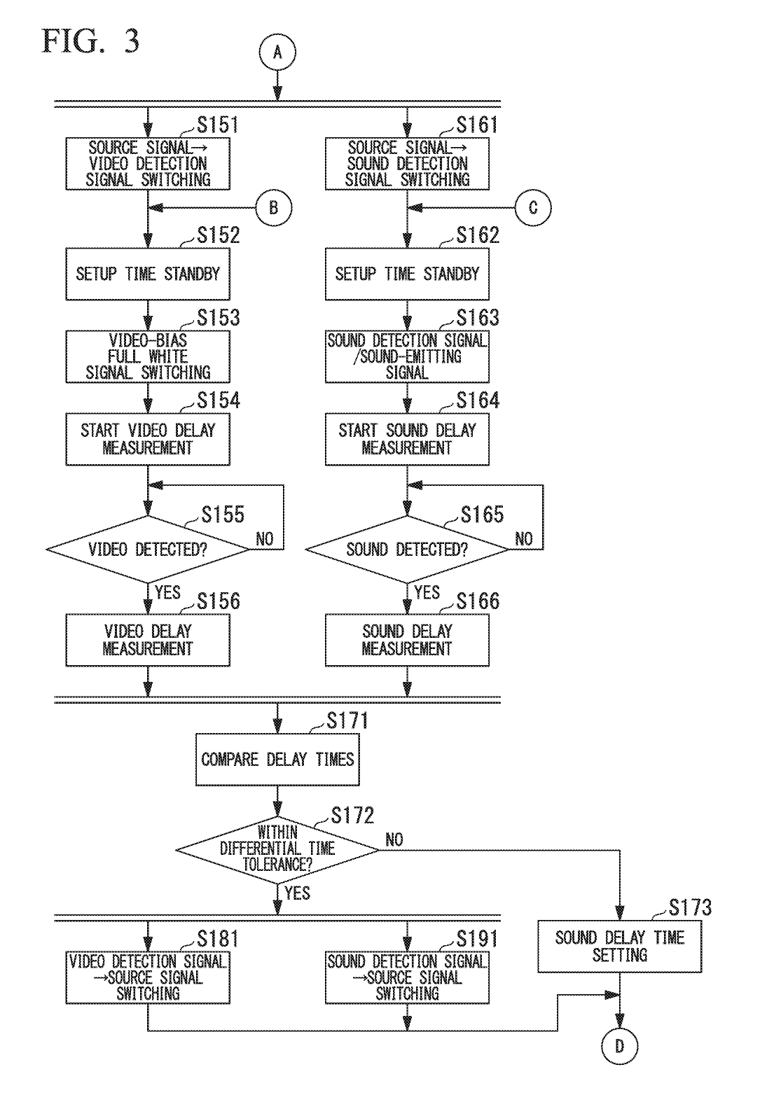

FIGS. 2 and 3 are flowcharts used to explain the operation of the display device 1 exemplified in the first embodiment.

In the flowcharts of FIGS. 2 and 3, symbols using double lines are symbols representing simultaneity; hence, multiple processes started with double lines do not have mutually dependent relationship, and therefore they are carried out in parallel. Multiple processes ended with double lines show processes which are completed, thereafter, it is possible to proceed to next processes following double lines.

In FIG. 2, the synchronous detection/DE detection part 101a detects a synchronization signal for a video input signal serving as an analog signal (S101). Next, the synchronous detection/DE detection part 101a detects a data enable signal for a video input signal serving as a digital signal (S102).

In the case of a video input signal serving as an analog signal, the video mask pulse generator 101b generates a video mask pulse based on the synchronization signal detected by the synchronous detection/DE detection part 101a (S103).

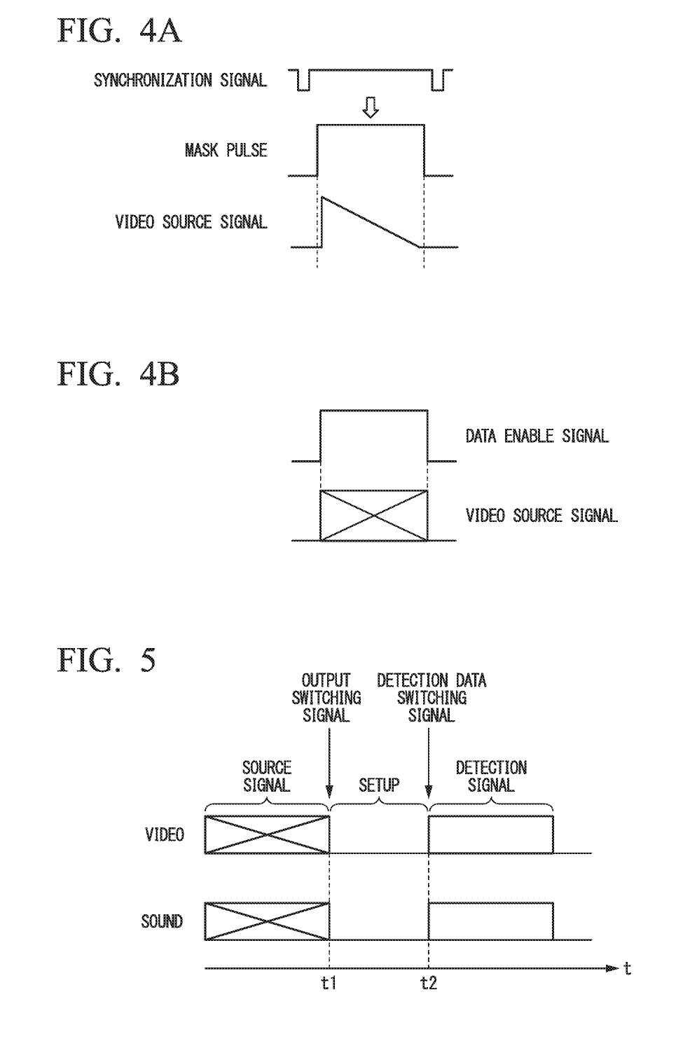

The content of processing involved in steps S101 to S103 will be described using timing charts shown in FIGS. 4A and 4B. FIG. 4A is a timing chart used to explain how to generate a mask pulse, used to generate a video detection signal, with respect to a video input signal serving as an analog signal. FIG. 4B is a timing chart used to explain how to detect a data enable signal with respect to a video input signal serving as a digital signal.

In FIG. 4A, a video input signal serving as an analog signal includes a video component included in a video source signal interposed between pulses of a synchronization signal shown in the first stage of FIG. 4A. The video mask pulse generator 101b generates a video mask pulse based on a video input signal input thereto.

A video source signal includes a video component having a sawtooth waveform shown in the third stage of FIG. 4B. The video component emerges in a narrower range (or a time length) than a range between pulses of a synchronization signal. The video mask pulse generator 101b generates a video mask signal having a time length able to mask the video component included in a first video source signal of a video input signal as shown by dotted lines shown in the second stage of FIG. 4B.

In FIG. 4B, the synchronous detection/DE detection part 101a detects a DE signal included in a video source signal from a video input signal serving as a digital signal. The time length of a DE signal is identical to a time length of a video input signal. Therefore, it is unnecessary to generate a mask pulse, which should be generated for an analog signal, with respect to a video input signal serving as a digital signal.

The video pulse generator 101 generates a mask pulse or a DE signal for each frequency or each type of a video detection signal. The video detection signal generator 104 generates a video detection signal, which is used for measurement of a delay time which will be described later, based on a mask pulse or a DE signal generated by the video pulse generator 101. Therefore, the measurement of a delay signal is carried out using a video detection signal which is generated for each frequency or each type of a video detection signal.

Returning back to FIG. 2, steps S111 and S121, which are carried out concurrently with step S101, will be described.

By switching a video bias (S111), the video data generator 102 generates first video data corresponding to a full black video and second video data corresponding to a full white video (S112). The video data generator 102 generates and outputs first and second video data to the video data switch 103. According to a detection data switching signal given by the switching signal generator 108, the video data switch 103 outputs either first video data or second video data to the video detection signal generator 104.

After completion of steps S103 and S112, the video detection signal generator 104 generates a video detection signal (S131).

The video detection signal generator 104 replicates a video input signal so as to carry out masking by multiplying a first video source signal, included in the replication of a video input signal, by video mask pulse which is generated in step S103. Additionally, the video detection signal generator 104 replaces part of a video source signal subjected to masking with either first video data or second video data which is generated in step S112, thus generating a second video source signal. The video detection signal generator 104 generates a video detection signal including the second video source signal and the second synchronization signal replicating the first synchronization signal.

Concurrently with step S111, the sound detection signal generator 113 switches a sound signal used for a sound detection signal with a silent signal (S121) so as to generate a silence-type sound detection signal (S122).

After completion of steps S131 and S122, the switching signal generator 108 determines whether or not an explicit instruction is made to execute compensating for a delay time due to a user operation (S141). Herein, a user may instruct whether to execute compensating for a delay time at an arbitrary timing. Without any user operation (S141—NO), the switching signal generator 108 determines whether or not any change occurs in a video input signal by detecting whether or not a detection flag is input thereto from the signal detector 107 (S142).

With any change occurring in a video input signal (S142—YES), or with any user operation in step S141 (S141—YES), the flow goes to a connector “A” shown in FIG. 3.

Without any change in a video input signal (S142—NO), the comparator 108 determines whether or not a difference (or a differential time) between the delay time output from the video delay measuring part 111 and the delay time output from the sound delay measuring part 117 falls within a predetermined tolerance (S143).

When a differential time does not fall within a predetermined tolerance (S143—NO), the flow goes to a connector “B” or “C” shown in FIG. 3. The step S143 makes a decision of NO when a differential time is not calculated.

When a differential time falls within a predetermined tolerance (S143—YES), the display device 1 determines whether or not an exit operation is made by user (S144).

It is unnecessary to carry out a compensating operation for a delay time, which will be described later, since a deviation between video display and sound output falls within a predetermined range when a differential time falls within a predetermined tolerance.

The exit operation is an operation to terminate a compensating operation for a delay time. For example, it is an operation of turning off an unillustrated power switch of the display device 1. When the display device 1 includes an “auto/manual” switch to establish automatic or manual setting for executing compensation for a delay time, for example, manual setting of the switch can be regarded as the exit operation in step S144.

With an exit operation (S144—YES), the display device 1 exits the processing described in the flowchart.

Without an exit operation (S144—NO), the flow goes back to steps S111 and S121.

In FIG. 3 following the connector “A” in FIG. 2, a series of steps S151 to S156 and a series of steps S161 to S166 are carried out concurrently.

The switching signal generator 108 sends an output switching signal to the first switch 105 so as to cause the first switch 105 to switching its output from a video input signal to a video detection signal (S151). The video detection signal being switched from the video input signal is full black video data, which is set in step S111, and therefore the display 109 displays a full black video.

Next, the ongoing flow meets another flow following the connector “B” in FIG. 2, whereby the video delay measuring part 111 waits for a setup time (S152). The setup time is used to synchronize with the preparation for the measurement of the sound delay measuring part 117 by providing a predetermined standby time after a video input signal is switched to a full black video detection signal. By providing the predetermined standby time, it is possible to stabilize the video detector 110 measuring a full black video, thus preventing erroneous measurement due to noise. In this connection, the video delay measuring part 111 may activate measurement of delay times after confirming no change occurring on the video detector 110 measuring a full black video.

Next, the switching signal generator 108 sends a display data switching signal to the video data switch 103, which in turn output video data based on video bias of full white data (S153).

Next, the video delay measuring part 111 starts measuring a delay time via a display data switching signal given by the switching signal generator 108 (S154). Next, the video detector 110 detects whether or not a full black video is turned into a full white video (S155). The display device 1 repeats step S155 when the video detector 110 does not detect a full white video (S155—NO). When the video detector 110 detects a full white video (S155—YES), the video delay measuring part 111 measures a delay time with respect to a video display operation (S156).

The switching signal generator 108 sends an output switching signal to the second switch 114, which in turns switches its output signal from a sound input signal to a sound detection signal (S161). The sound detection signal being switched to is a silence-type sound signal which is set in step S121.

Next, the ongoing flow meets another flow following a connector “C” in FIG. 2, and therefore the sound delay measuring part 117 waits for a setup time (S162). The setup time is used to provide a predetermined standby time after a sound input signal is switched to a silence-type sound detection signal, thus establishing synchronization with preparation of measurement in the video delay measuring part 111.

Next, the switching signal generator 108 starts measuring a delay time via a display data switching signal given by the switching signal generator 108 (S164). Next, the sound delay measuring part 117 detects whether or not a sound signal is changed from a silent signal to a sound-emitting signal (S165). The display device 1 repeats step S165 when the sound delay measuring part 117 fails to detect a sound-emitting signal (S165—NO). When the sound delay measuring part 117 detects a sound-emitting signal (S165—YES), the sound delay measuring part 117 measures a delay time with respect to a sound output operation (S166).

A series of steps S151 to S153 and a series of steps S161 to S163 will be described with reference to FIG. 5. FIG. 5 is a timing chart used to explain how to generate a video detection signal and a sound detection signal.

In FIG. 5, an x-axis represents a time axis. At time t1, the first switch 105 changes its output signal due to an output switching signal in steps S151 and S161 such that a video source signal of a video input signal is switched from a first video source signal to a second video source signal replacing its video data with first video data (or a full black video). At time t1, sound data is changed from a sound input signal to a silent signal.

The period of time between times t1 and t2 is the setup time in steps S152 and S162.

At time t2, due to a detection data switching signal in steps S153 and S163, a video source signal of a video input signal is switched from first video data to second video data (or a full white video), while a sound signal is switched from silent data to sound-emitting data used for detection.

After time t2, a detection signal is continuously output.

Returning back to FIG. 3, the comparator 118 compares a delay time measured by the video delay measuring part 111 with a delay time measured by the sound delay measuring part 117 so as to calculate a difference of delay times (i.e. a differential time) (S171).

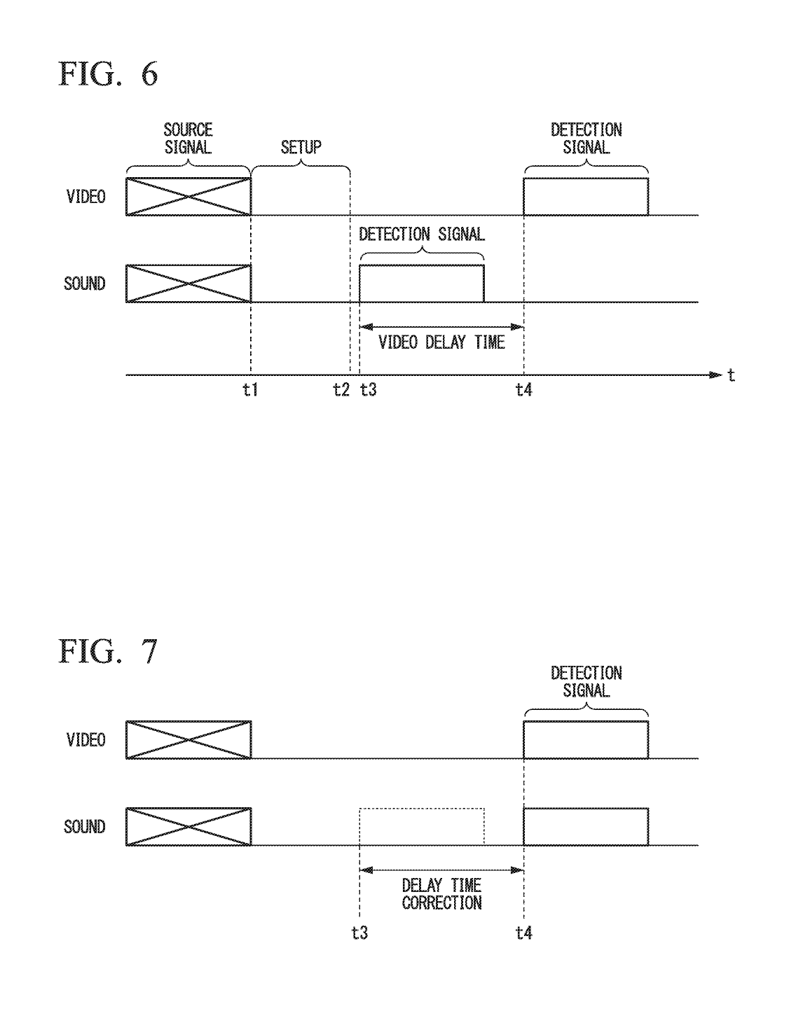

A series of steps S154 to S156 and a series of steps S164 to S166 will be described with reference to FIG. 6. FIG. 6 is a timing chart used to explain how to measure a delay time.

In FIG. 6, the sound delay measuring part 117 detects a sound detection signal (or a sound-emitting signal) at time t2. Additionally, the video delay measuring part 111 detects a video detection signal (or a full white video) at time t4. That is, (t4−t3) represents a difference between a delay time measured by the video delay measuring part 111 and a delay time measured by the sound delay measuring part 117. The present embodiment measures a differential time as (t4−t3).

Returning back to FIG. 3, the comparator 118 determines whether or not a differential time falls within a predetermined range (S172). The comparator 118 sends a processing-completion flag to the switching signal generator 108 when a differential time falls within a predetermined range (S172—YES). The switching signal generator 108 stops sending an output switching signal in response to a processing-completion flag input thereto.

Due to stoppage of an output switching signal, the first switch 105 switches its output signal from a video detection signal to a video input signal (or a source signal) (S181). Due to stoppage of an output switching signal, the second switch 114 switches its output signal from a sound detection signal to a sound input signal (or a source signal) (S191).

When a differential time does not fall within a predetermined range (S172—NO), the comparator 118 sends a delay correction value, which is calculated based on a differential time, to the sound delay processor 115. The sound delay processor 115 applies the delay correction value to its internal setting (S173).

The flow continues to a connector “D” in FIG. 2.

A series of steps S171 to S173 will be described with reference to FIG. 7. FIG. 7 is a timing chart used to explain how to compensate for a delay time.

In FIG. 7, a delay correction value corresponding to a differential time t4−t3 is set to the sound delay processor 115, and therefore a delay time for a sound signal is adjusted to a delay time for a video signal at time t4, thus eliminating any deviation between a video output timing and a sound output timing.

In this connection, a delay correction value set to the sound delay processor 115 is not necessarily set to the same value as the differential time. For example, it is possible to set a delay correction value to a fixed value. Even when it is determined in step S143 that a difference between delay times being compensated using a delay correction value does not fall within a predetermined tolerance, for example, a difference between delay times will converge into a predetermined tolerance by repeatedly executing a compensation process for delay times explained with reference to FIG. 3. For this reason, the sum of delay correction values will become based on a difference of delay times.

Due to a large distance lying between the display 109 and a user watching the display 109, a difference occurs between a time at which a light beam of video displayed on the display 109 reaches a user and a time at which a sound output by the sound output part 119 reaches a user. It is possible to set a delay correction value, which is set to the sound delay processor 115, in consideration of a distance between the display 109 and a user.

### Second Embodiment

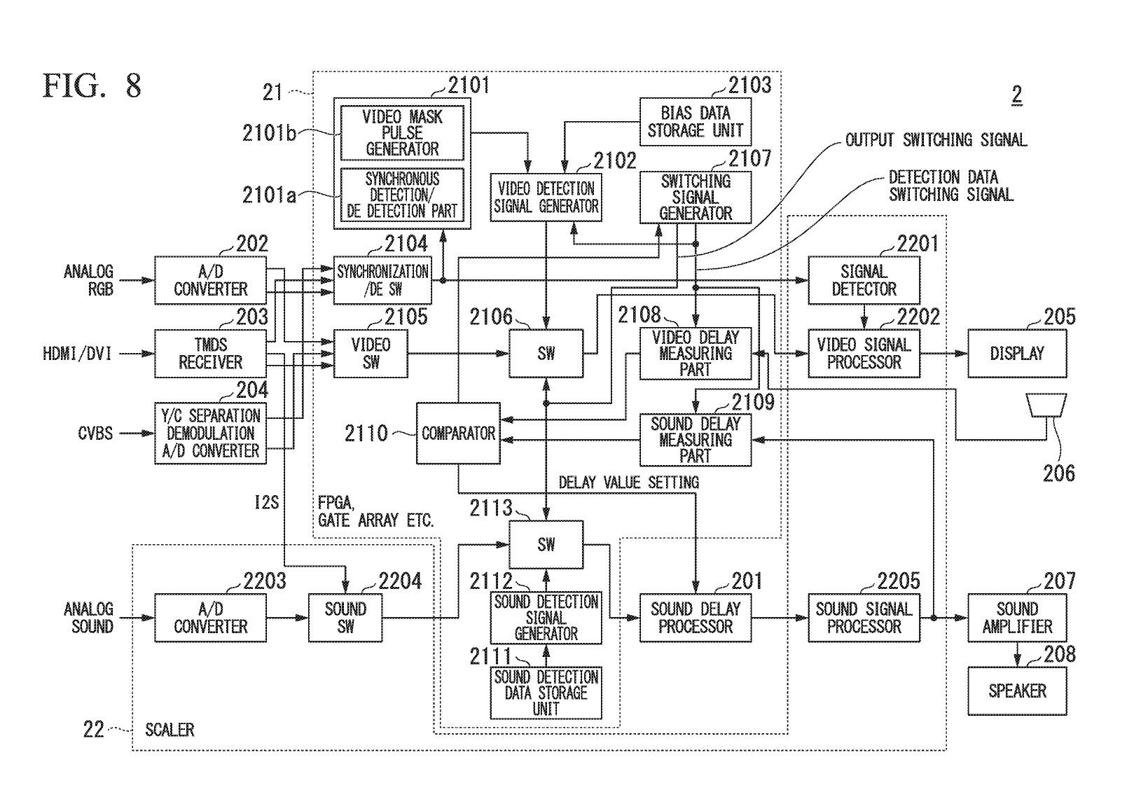

Next, a display device according to the second embodiment will be described with reference to FIG. 8. FIG. 8 is a functional block diagram used to explain the configuration of a display device exemplified in the second embodiment.

In FIG. 8, a display device 2 includes a sound delay processor 201, an A/D (Analog/Digital) converter 202, a TMDS (Transition Minimized Differential Signaling) receiver 203, a Y/C (i.e. luminance signal/color signal) separation demodulation A/D converter 204, a display 205, a video detector 206, a sound amplifier 207, a speaker 208, a first controller 21, and a second controller 22.

The first controller 21 includes a video pulse generator 2101 (i.e. a synchronous detection/DE detection part 2101a, a video mask pulse generator 2101b), a video detection signal generator 2102, a bias data storage unit 2103, a synchronization/DE SW (Switch) 2104, a video SW 2105, a SW 2106, a switching signal generator 2107, a video delay measuring part 2108, a sound delay measuring part 2109, a comparator 2110, a sound detection data storage unit 2111, a sound detection signal generator 2112, and a SW 2113.

The second controller 22 includes a signal detector 2201, a video signal processor 2202, an A/D converter 2203, a sound SW 2204, and a sound signal processor 2205.

In this connection, modules having the same names as the first embodiment are assumed to have the same functions; hence, their descriptions will be omitted.

For example, the first controller 21 can be embodied using FPGA (Field Programmable Gate Array), gate arrays, or the like. Additionally, the second embodiment can be embodied using scalers or the like. It is possible to easily configure the display device 2 since, for example, the second embodiment can be embodied by newly combining FPGA or the like with the existing scaler.

The second embodiment arranges the sound delay processor 201 independently of the first controller 21 or the second controller 22; however, it is possible to install the sound delay processor 201 in either the first controller 21 or the second controller 22.

The second embodiment dispersively installs the functions of modules, installed in the first embodiment which is described with reference to FIG. 1, in the first controller 21 and the second controller 22.

For example, the first controller 21 embodies the functions of modules that are described in the first embodiment by arranging the video pulse generator 2101, the video detection signal generator 2102, SW 2016, the switching signal generator 2107, the video delay measuring part 2108, the sound delay measuring part 2109, the comparator 2110, the sound detection data storage unit 2111, the sound detection signal generator 2112, and the SW 2113.

The SW 2106 has the function equivalent to the function of the first switch 105 in the first embodiment, while the 2113 has the function equivalent to the function of the second switch 114. The bias data storage unit 2103 has the function equivalent to the function of the video data generator 102. The sound amplifier 207 and the speaker 208 share the function equivalent to the function of the sound output part 119.

The detection/DE SW 2104 and the video SW 2105 receive an analog RGB signal, a HDMI (a registered trademark)/DVI (High Definition Multimedia Interface/Digital Visual Interface) signal, and a synchronization signal (or a DE signal) of a CVBS (Composite Video Blanking Sync) signal from the A/D converter 202, the TMDS receiver 203, and the Y/C separation demodulation A/D converter 204 so as to changes those signals with video signals.

The A/D converter 2203 converts an analog signal input thereto into a digital signal, while the sound SW 2204 changes its output signal to the SW 2113 between an I2S (Inter-IC Sound) digital sound signal, given by the TMDS receiver 203, and an I2S digital sound signal, given by the A/D converter 2203. For example, it is possible to use an I2S transmission form for a sound signal given by the TMDS receiver 203. Herein, I2S is a transmission form mainly used for inter-IC sound signals. As a transmission form of a sound signal, it is possible to use an optical digital sound signal mainly used for transmitting a sound signal between external interfaces.

### Third Embodiment

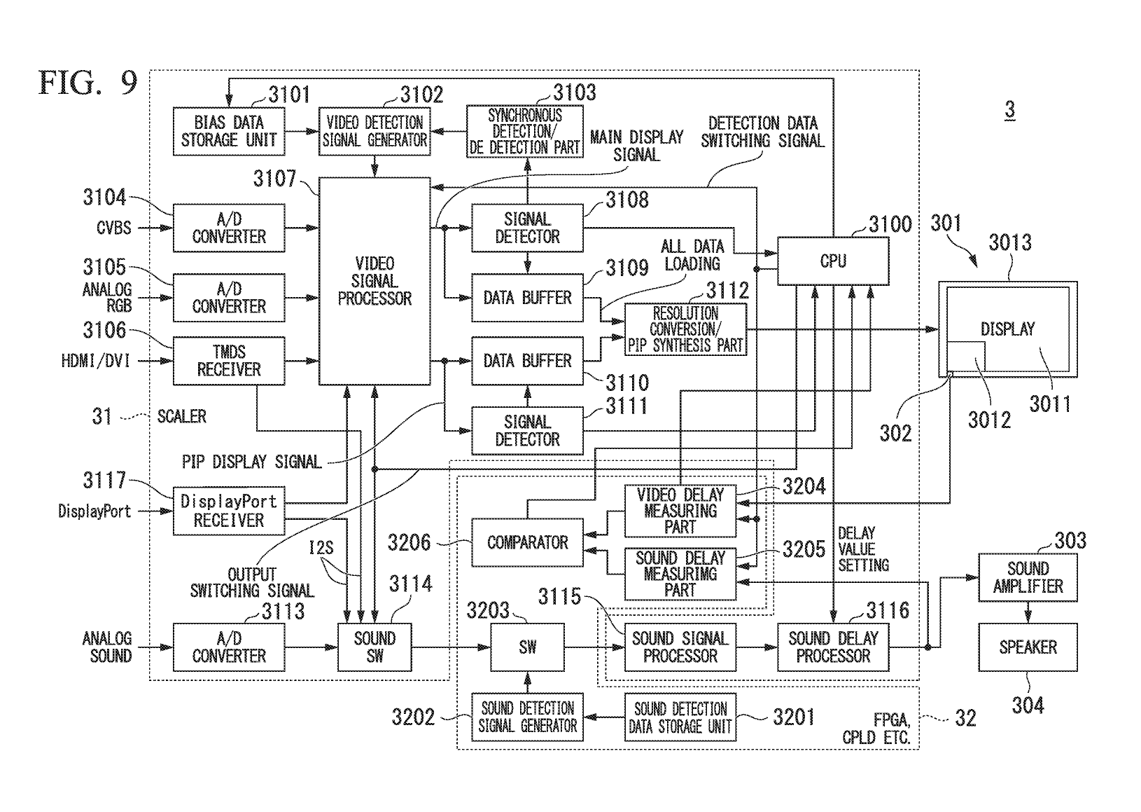

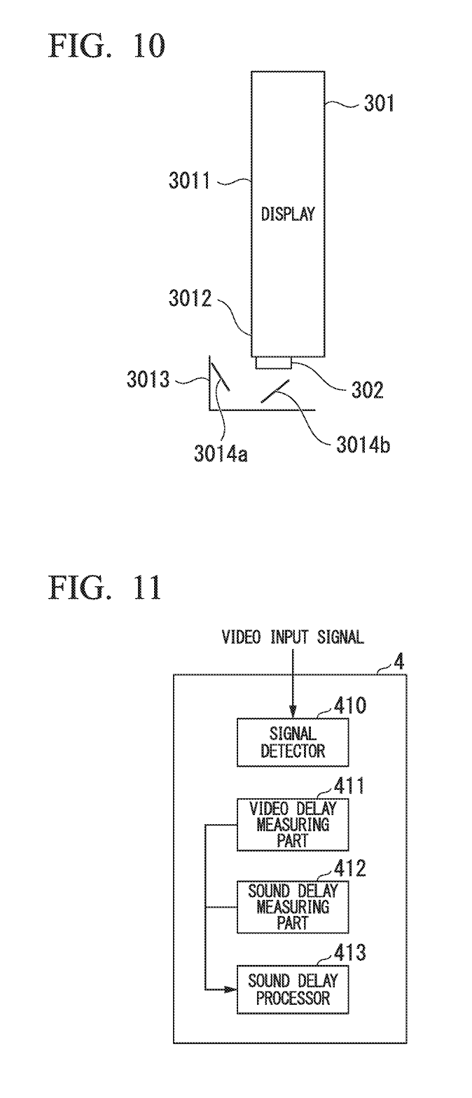

Next, a display device according to the third embodiment will be described with reference to FIGS. 9 and 10. The third embodiment exemplifies a display device having a main screen and a sub-screen with respect to videos displayed on a display that detects a display operation of a sub-screen so as to compensate for a delay time. FIG. 9 is a functional block diagram used to explain the configuration of a display device exemplified by the third embodiment.

In FIG. 9, a display device 3 includes a display 301, a video detector 302, a sound amplifier 303, a speaker 304, a first controller 31, and a second controller 32.

The display 301 includes a main screen 3011, a sub-screen 3012, and a bezel 3013.

The display 301 displays a video on the main screen 3011 while arranging the sub-screen 3012 within the main screen 3011 so as to display another video different from the video of the main screen 3011 on the sub-screen 3012. The present embodiment exemplifies PIP (Picture In Picture) applied to the display 301 in which a video of the sub-screen 3012 is displayed inside a video of the main screen 3011. In this connection, the present embodiment needs to set any areas for displaying different videos by use of the main screen 3011 and the sub-screen 3012. For example, it is possible to set areas not overlapping each other with respect to the main screen 3011 and the sub-screen 3012.

The first controller 31 includes a CPU 3100, a bias data storage unit 3101, a video detection signal generator 3102, a synchronous detection/DE detection part 3103, an A/D converter 3105, a TMDS receiver 3106, a video signal processor 3107, a signal detector 3108, a data buffer 3109, a data buffer 3110, a signal detector 3111, a resolution conversion/PIP synthesis part 3112, an A/D converter 3113, a sound SW 3114, a sound signal processor 3115, a sound delay processor 3116, and a DisplayPort receiver 3117.

The second controller 32 includes a sound detection data storage unit 3201, a sound detection signal generator 3202, a SW 3203, a video delay measuring part 3204, a sound delay measuring part 3205, and a comparator 3206.

In the third embodiment, for example, the first controller 31 can be embodied using a scaler or the like. For example, the second controller 32 can be embodied using FPGA, gate arrays, or the like.

For example, the third embodiment can be embodied using FPGA newly combined with the existing scaler; hence, it is possible to configure the display device with ease.

Herein, details of the display 301 will be described with reference to FIG. 10. FIG. 10 is a side view of the display 301 in the third embodiment. The display 301 includes the main screen 3011 for displaying a video and the sub-screen 3012 disposed under the main screen 3011. The bezel 3013 is arranged below the display 301, wherein the bezel 3013 is equipped with reflection boards 3014a and 3014b.

A video displayed on the sub-screen 3012 is reflected by the reflection boards 3014a, 3014b and then introduced into the video detector 302. FIG. 10 shows the bezel 3013 having an upper opening. For example, it is possible to close the upper portion of the bezel 3013 with a plastic board or a glass board which can transmit a light beam of a video displayed on the sub-screen 3012 therethrough.

Returning back to FIG. 9, the DisplayPort receiver 3117 receives a DisplayPort signal. The video signal processor 3107 switches over a CVBS signal, an analog RGB signal, a HDMI/DVI signal, and a DisplayPort signal so as to send a main display signal to the signal detector 3108 and the data buffer 3109. The main display signal is a video input signal which is displayed on the main screen 3011.

The video signal processor 3107 receives a video detection signal, given by the video detection signal generator 3102, so as to send a PIP display signal to the data buffer 3110 and the signal detector 3111. The PIP display signal is a video signal displayed on the sub-screen 3012.

The signal detector 3108 has the same function as the function of the signal detector 107. Upon detecting any variations occurring on each input signal (i.e. a CVBS signal, an analog RGB signal, a HDMI/DVI signal, or the like), the synchronous detection/DE detection part 3103 produces its detection result.

The bias data storage unit 3101, the video detection signal generator 3102, and the synchronous detection/DE detection part 3103 generate a video detection signal based on the detection result given by the video detection signal generator 3102. The operation of the video detection signal generator 3102 generating a video detection signal is identical to the operation of the first embodiment.

The data buffer 3109 and the data buffer 3110 temporarily save a main display signal and a PIP display signal. The main display signal and the PIP display signal are forwarded to the resolution conversion/PIP synthesis part 3112 in synchronism with synchronization signals output from the signal detector 3108 and the signal detector 3111. The resolution conversion/PIP synthesis part 3112 synthesizes the main display signal and the PIP display signal so as to send a synthesized signal to the display 301.

The third embodiment differs from the second embodiment, which detects a video detection signal displayed on the entire screen of the display 205, in that the third embodiment detects a video detection signal displayed on the sub-screen 3012. The third embodiment is able to detect a video detection signal on the sub-screen 3012 while displaying a video source signal on the main screen 3011; hence, it is possible to carry out delay compensation without causing interruption in displaying video source signals. For example, it is possible to display a video on the sub-screen 3012 only when executing delay compensation.

### Fourth Embodiment

Next, a display device according to the fourth embodiment will be described with reference to FIG. 11. FIG. 11 is a functional block diagram used to explain the configuration of a display device exemplified in the fourth embodiment.

In FIG. 11, a display device 4 includes a signal detector 410, which detects variations occurring in a video input signal, a video delay measuring part 411, which measures a delay time concerning a video display operation based on a video input signal when the signal detector 410 detects any variations in a video input signal, a sound delay measuring part 412, which measures a delay time concerning processing of a sound signal when the signal detector 410 detects any variations in a video input signal, and a sound delay processor 413, which sets a delay time for a sound signal based on the delay time measured by the video delay measuring part 411 and the delay time measured by the sound delay measuring part 412.

As described above, the display devices 1 to 4 according to the foregoing embodiments can be each realized using a computer connectible to each display device. In this case, programs for realizing the functions of the blocks which are described with reference to FIGS. 1, 8, 9, and 11 are stored in computer-readable storage media; hence, a computer system reads programs stored in storage media so as to execute them. Herein, the term “computer system” may embrace OS and hardware such as peripheral devices. Additionally, the term “computer-readable storage media” may refer to flexible disks, magneto-optic disks, ROM, portable media such as CD-ROM, and storage devices such as hard disks embedded in computer systems. Moreover, the term “computer-readable storage media” may embrace any measures able to temporarily hold programs, e.g. any means for dynamically holding programs in short periods of time such as networks, the Internet, telephone lines, and communication lines able to transmit programs as well as volatile memory embedded in computer systems serving as servers and clients. The foregoing programs may realize part of the foregoing functionality; the foregoing programs may be combined with pre-installed programs of computer systems so as to realize the foregoing functionality; alternatively, the foregoing programs may be realized using programmable logic devices such as FPGA (Field Programmable Gate Array) or the like.

Hereinafter, the present invention is described using the foregoing embodiments with reference to the drawings; however, concrete configurations should not be limited to the embodiments; hence, the present invention may embrace any designs not departing from the essential elements of the invention.

### INDUSTRIAL APPLICABILITY

The above exemplified embodiments are applicable to display devices, display methods, and display programs.

### REFERENCE SIGNS LIST

1, 2, 3 display device
101, 2101 video pulse generator
101a, 2101a, 3103 synchronous detection/DE detection part
101b, 2101b video mask pulse generator
102 video data generator
103 video data switch
104, 2102, 3102 video detection signal generator
105 first switch
106, 2202, 3107 video signal processor
107, 2201, 3108, 3111, 410 signal detector
108, 2107 switching signal generator
109, 205, 301 display
110, 206, 302 video detector
111, 2108, 3204, 411 video delay measuring part
112, 2111, 3201 sound detection data storage unit
113, 2112, 3202 sound detection signal generator
114 second switch
115, 201, 3116, 413 sound delay processor
116, 2205, 3115 sound signal processor
117, 2109, 3205, 412 sound delay measuring part
118, 2110, 3206 comparator
119 sound output part
21, 31 first controller
2103, 3101 bias data storage unit
2104 synchronization/DE SW
2105 video SW
2106, 2113, 3203 SW
202, 2203, 3104, 3105, 3113 A/D converter
203, 3106 TMDS receiver
204 Y/C separation demodulation A/D converter
22, 32 second controller
2204, 3114 sound SW
207, 303 sound amplifier
208, 304 speaker
3011 main screen
3012 sub-screen
3013 bezel
3014a, 3014b reflection board
3100 CPU
3109, 3110 data buffer
3112 resolution conversion/PIP synthesis part
3117 DisplayPort receiver

1. A display device comprising:
a signal detector configured to detect variations in a video input signal input thereto;
a video delay measuring part configured to measure a video delay time concerning a video display operation based on the video input signal when the signal detector detects variations in the video input signal;
a sound delay measuring part configured to measure a sound delay time concerning processing of a sound signal input thereto when the signal detector detects variations in the video input signal; and
a sound delay processor configured to delay the sound signal based on the video delay time.

2. The display device according to claim 1, further comprising a video detection signal generator configured to generate a video detection signal based on the video input signal, wherein the video delay measuring part measures the video delay time based on the video detection signal generated by the video detection signal generator.

3. The display device according to claim 2, wherein the video input signal includes a first synchronization signal, and wherein the video detection signal generator generates a second synchronization signal based on the first synchronization signal so as to generate the video detection signal including the second synchronization signal.

4. The display device according to claim 3, wherein the video detection signal generator generates the second synchronization signal equivalent to the first synchronization signal.

5. The display device according to claim 2, wherein the video input signal includes a first video source signal, and wherein the video detection signal generator generates a second video source signal based on the first video source signal so as to generate the video detection signal including the second video source signal.

6. The display device according to claim 5, wherein the video detection signal generator generates the second video source signal by replacing part of the first video source signal with predetermined video data.

7. The display device according to claim 6, wherein the video detection signal generator generates a first video detection signal and a second video detection signal based on the video input signal,
wherein the second video source signal included in the first video detection signal is a signal replacing part of the video source signal with first video data,
wherein the second video source signal included in the second video detection signal is a signal replacing part of the first video source signal with second video data, and
wherein the video delay measuring part measures the video delay time due to video switching for switching the video detection signal from the first video detection signal to the second video detection signal.

8. The display device according to claim 7, wherein the first video data is video data corresponding to a full black video while the second video data is video data corresponding to a full white video.

9. The display device according to claim 2, further comprising:
a display configured to display a detecting video based on the video detection signal; and
a detector configured to detect luminance of the detecting video displayed on the display,
wherein the video delay measuring part measures the video delay time based on the luminance detected by the detector.

10. The display device according to claim 9, wherein the display concurrently displays the detecting video and an input video based on the video input signal.

11. A display method comprising:
detecting variations in a video input signal input thereto;
measuring a video delay time concerning a video display operation based on the video input signal undergoing variations in the video input signal;
measuring a sound delay time concerning processing of a sound signal input thereto in association with the video input signal undergoing variations; and
delaying the sound signal based on the video delay time and the sound delay time.

12. A non-transient computer-readable storage medium storing a program causing a computer of a display device to implement the display method according to claim 11.
